(19) United States
(12) Patent Application Publication
(10) Pub. No.: US 2013/0177925 A1
(43) Pub. Date: Jul. 11, 2013

(54) DETECTION OF ANTIGEN-SPECIFIC PERIPHERAL BLOOD MONONUCLEAR CELLS AND METHODS FOR DIAGNOSING IMMUNE DISORDERS

(71) Applicants: Jean Paul Soulillou, Nantes (FR); Sophie Brouard, Nantes (FR); Ahmed Akl, Nantes (FR)

(72) Inventors: Jean Paul Soulillou, Nantes (FR); Sophie Brouard, Nantes (FR); Ahmed Akl, Nantes (FR)

(73) Assignees: INSTITUT NATIONAL DE LA SANTE ET DE LA RECHERCHE MEDICALE (INSERM), Paris (FR); CHU NANTES, Nantes Cedex 1 (FR); UNIVERSITE DE NANTES, Nantes (FR)

(21) Appl. No.: 13/704,823

(22) PCT Filed: Jun. 17, 2011
(86) PCT No.: PCT/EP2011/060103

§ 371 Date: Mar. 14, 2013

(30) Foreign Application Priority Data
Jun. 17, 2010 (EP) 10305650.3

(51) Int. Cl. G01N 21/64

(52) U.S. Cl. CPC G01N 21/6486
USPC 435/7.21

(57) ABSTRACT

The present invention relates to a method for detecting the presence or the absence, and optionally quantifying and/or isolating, antigen-specific peripheral blood mononuclear cells. This method, which involves flow cytometry, is based on the use of a fluorescently-labeled antibody specifically recognizing peripheral blood mononuclear cells, and of fluorescently-labeled beads coated with at least one antigen that is specifically recognized by antigen-specific peripheral blood mononuclear cells. The method according to the invention is for example useful for diagnosing immune disorders such as transplant rejections and autoimmune disorders.

### FIELD OF THE INVENTION

The present invention relates to a method for detecting the presence or the absence, and optionally quantifying and/or isolating, antigen-specific peripheral blood mononuclear cells. This method, which involves flow cytometry, is based on the use of a fluorescently-labeled antibody specifically recognizing peripheral blood mononuclear cells, and of fluorescently-labeled beads coated with at least one antigen that is specifically recognized by antigen-specific peripheral blood mononuclear cells. The method according to the invention is for example useful for diagnosing immune disorders such as transplant rejection and autoimmune disorders.

### BACKGROUND OF THE INVENTION

Transplantation has become a major public health challenge since more than 250 000 Europeans are currently living with a transplanted organ and 80 000 people are awaiting a transplant.

If the number of successful transplantation is increasing yearly, chronic rejection still often leads to long-term graft rejection. The diagnosis of these rejection cases relies on the presence of characteristic histological lesions, such as interstitial fibrosis, tubular atrophy and glomerulopathy transplant, on the presence of diffuse C4d deposits in peritubular capillaries, and also on the presence of circulating antibodies directed against HLA donor.

Recent prospective studies have reported the effect of these circulating antibodies directed against HLA donor on the long-term graft and showed that patients who developed antibodies to donor had a higher risk of rejecting their graft.

However, while the role of antibodies in the donor graft has become well studied, the role of antigen-specific Peripheral Blood Mononuclear Cells (PBMC) and in particular of antigen-specific B lymphocytes (circulating or infiltrating the graft) remains as of today much less clear. Yet, the results of anti-CD20 treatments administered to transplantated patients suggest that these antibodies may play an important role in the pathogenesis of chronic rejection. Furthermore, their presence has been demonstrated in transplant.

However, the correlation between the frequency of these antigen-specific PBMC or antigen-specific B lymphocytes directed against the donor's HLA, the appearance of HLA antibodies and the future of transplantation has never been specifically studied and remains poorly understood as of today. One reason explaining the lack of studies on that matter relies on the lack of a technology that can easily and quickly be implemented and allowing the detection of antigen-specific B lymphocytes directed against the donor's HLA.

An immunofluorescence staining method to select and sort antigen-specific B lymphocytes is provided by WO 93/18068. This method relies on the use of a single antigen bearing two different fluorochromes. However, a subsequent PCR step is needed in order to obtain a satisfactory sensitivity. Moreover, this method does not allow isolating of the antigen-specific B lymphocytes.

WO/2004/102198 provides a method for visualizing and selecting of antigen specific B lymphocytes which relies on the use a virus like particle (VLP) endowed with an ordered and repetitive antigen or antigenic determinant. WO/2008/118926 discloses a method for direct quantification and isolation of antigen-specific B lymphocytes by flow cytometry, based on the use of antigen-Ig Ab fusion molecules. Hence, these two methods both require the design of a dedicated tool (either the appropriate virus like particle, or the appropriate fusion protein) prior to implementation of the method.

As of today, an easy but specific and reliable technique to detect, sort and retrieve an antigen-specific PBMC subpopulation is needed to ease the routine implementation of the detection of antigen-specific B lymphocytes directed against the donor's HLA in laboratories. Hence, detecting and sorting antigen-specific PBMC, and in particular isolating, antigen-specific B lymphocytes, would improve the understanding of the immune response, enable earlier diagnosis and enable the design of specific treatments of transplant rejection. In addition, the detection of antigen-specific PBMC would also allow the diagnosis of other immune disorders in which BPMC play a role.

There is therefore a need in the art for a method for detecting the presence or the absence, and optionally quantifying and/or isolating, antigen-specific peripheral blood mononuclear cells.

### DESCRIPTION OF THE INVENTION

The inventors have unexpectedly found a handy method which allows detecting, quantifying and isolating an antigen-specific PBMC subpopulation such as e.g. HLA specific B lymphocytes. This method is based on the use of a fluorescently-labeled antibody specifically recognizing PBMC on the one hand, and fluorescently-labeled beads coated with at least one antigen that is specifically recognized by the antigen-specific peripheral blood mononuclear cells subpopulation to be detected (e.g. HLA-specific PBMC) on the other hand.

FIGS. 1 and 2 are schemes representing the method according to the invention. The PBMC population is detected with a fluorescently-labeled antibody specifically recognizing PBMC (“2” on FIG. 1), thereby yielding a first complex (“3” on FIG. 1). The antigen-specific PBMC subpopulation is further detected with fluorescently-labeled beads (“4” on FIG. 1), thereby yielding a second complex (“5” on FIG. 1). As the first complex has only one fluorochrome and the second bead-antibody-cell complex has two of them, the complexes can be discriminated based on the fluorescent patterns, thus allowing the detection and quantification of the antigen-specific PBMC population by flow cytometry. In particular, the second complex can be visualized by flow cytometry thanks to its increased size and opacity (FIG. 2). If needed, the antigen-specific PBMC subpopulation may be isolated with a cell sorter for further characterization.

As shown in the examples, the method according to the invention allows a sensitive and specific detection and quantification of an antigen-specific PBMC subpopulation. In addition, the method according to the invention may be carried out using commercially available molecular tools such as, e.g., Labscreen® beads and commercially available conjugated antibodies. Therefore, it can be easily and widely implemented without the need of designing specific and complicated tools.

The method according to the invention finds use in diagnostic and prognostic applications. In particular, it is useful for the diagnosis and prognosis of immune disorders, and for drug monitoring of patients suffering from immune disorders.

Detection of Antigen-Specific Peripheral Blood Mononuclear Cells

Therefore, the present invention is drawn to a method for detecting the presence or the absence of at least one an antigen-specific peripheral blood mononuclear cell, said method comprising the steps of:
a) providing or obtaining a sample comprising peripheral blood mononuclear cells;
b) contacting said sample with a fluorescently-labeled antibody specifically recognizing a peripheral blood mononuclear cell (PBMC), whereby a first complex between said labeled antibody and said PBMC is formed;
c) contacting the sample obtained at step (b) with at least one fluorescently-labeled bead coated with an antigen that is specifically recognized by said antigen-specific PBMC, whereby, if said sample comprises antigen-specific PBMC, a second complex between beads and the first complex is formed;
d) detecting, by flow cytometry, the presence or the absence of said second complex, thereby detecting the presence or the absence of said antigen-specific PBMC;
e) optionally quantifying said second complex; and
f) optionally isolating said second complex;
   wherein said fluorescently-labeled antibody and said fluorescently-labeled beads are not labeled with the same fluorochrome.

The peripheral blood mononuclear cell (PBMC) can correspond to any blood cell having a round nucleus. Such cells are known to play a role in the immune response. PBMC include for instance lymphocytes such as T cells, B lymphocytes and NK cells, monocytes and macrophages.

The PBMC preferably correspond to a B lymphocyte. The term “B lymphocyte” refers herein to B lymphocytes at any stage of differentiation, including naive B lymphocytes, mature B lymphocytes, memory B lymphocytes, B1 cells, B2 cells and plasma B lymphocytes.

PBMC express markers at their cell surface, said markers differing from one PBMC population to another. For instance, B lymphocytes express CD19 at their cell surface, helper T cells express CD4 at their cell surface, cytotoxic T lymphocytes express CD8 at their cell surface, etc. As a consequence, a PBMC population may be detected through the use of an antibody specifically recognizing such a marker.

As used herein, the expression “antibody specifically recognizing a peripheral blood mononuclear cell (PBMC)” relates to any antibody specifically recognizing a marker present on a PBMC population. Examples of such antibodies include but are not limited anti-CD3 antibodies if the PBMC population to be detected is the T cell population, anti-CD4 antibodies if the PBMC population to be detected is the cytotoxic T lymphocyte (CTLs) population, and anti-CD19 or anti-CD20 antibodies if the PBMC population to be detected is the B lymphocyte population.

In a preferred embodiment, the PBMC correspond to B lymphocytes, and the antibody specifically recognizing B lymphocytes is an anti-CD19 antibody. As used herein, the term “CD19” refers to the B-lymphocyte antigen CD19 (see e.g. NCBI accession number AAA68490 and OMIM Accession Number 107265 for information on human CD19).

By “antigen-specific peripheral blood mononuclear cells (PBMC)” is meant a subpopulation of PBMC that expresses a given antibody specifically recognizing an antigen. As a consequence, this subpopulation of PBMC is capable of specifically recognizing said antigen, in contrast to other PBMC that do not express the antibody. As illustrated in example 2 to 4, the antigen-specific PBMC may for instance be an HLA-DRB4-specific B lymphocyte, an HLA-DPB1-specific B lymphocyte or an HLA-A0201-specific B lymphocyte. However, the skilled in the art can easily choose other antigen-specific PBMC to be studied and detected in accordance with the invention.

In a preferred embodiment, the antigen is an antigen encoded by the major histocompatibility complex (MHC). Such antigens are referred to as “HLA antigens” The HLA antigen detected in the frame of the present invention may correspond to an HLA antigen of class I (e.g. HLA-A, HLA-B, HLA-C), an HLA antigen of class II (e.g. HLA-DM, HLA-DP, HLA-DPA, HLA-DPB, HLA-DQ, and HLA-DR), an HLA antigen of class III, or a non classical HLA antigen. Such non classical HLA antigens correspond to antigens that are expressed under abnormal, aberrant and/or pathological conditions such as tumors, infections, inflammation, pregnancy, organ transplantation or autoimmune disorders. Examples of such non classical HLA antigens include HLA-E, -F, -G and -H, antigens.

In a specific embodiment, the antigen is an antigen indicative of a transplant rejection (e.g. an HLA antigen). In the frame of this embodiment, the sample is obtained from a patient who has received, or who is in need of receiving, a transplant from a donor. The antigen preferably corresponds to an antigen encoded by the MHC of the donor, but that is not encoded by the MHC of the patient. The skilled in the art can easily identify such antigens since the HLA profile of the patient and of the donor is systematically determined prior to a transplant.

In another specific embodiment, the antigen is an antigen indicative of an autoimmune disorder. In the frame of this embodiment, the sample is obtained from a patient suffering from, or at risk of suffering from, an autoimmune disorder. The antigen preferably corresponds to an auto-antigen indicative of an autoimmune disorder. For example, the myelin basic protein (MBP) may used to detect PBMC expressing antibodies directed to MBP in multiple sclerosis, and cytrulline may used to detect PBMC expressing antibodies directed to MBP in rheumatoid arthritis.

More generally, PBMC play a critical role in the immune response. Therefore, the sample can advantageously be obtained from a patient suffering from, or at risk of suffering from, an immune disorder. The antigen is then chosen to be indicative of the immune disorder.

The present invention may be implemented with any sample comprising peripheral blood mononuclear cells.

The sample may for example correspond to a biological sample, i.e. a sample obtained from an individual. Alternatively, it may correspond to a synthetic sample, such as a sample for calibration purpose. The biological sample may be derived from any mammal, for instance from a human individual, mouse, rat, rabbit, chicken, monkey, pig, guinea pig or dog. Preferably, the biological sample correspond to a blood sample, a plasma sample, a lymph node sample, a spleen sample, a liver sample or a urine sample.

In the frame of the method according to the invention, the antibody specifically recognizing a peripheral blood mononuclear cell (PBMC) and the beads coated with at least one antigen that is specifically recognized by an antigen-specific PBMC are fluorescently labeled, i.e., they are linked to a fluorochrome. Many fluorochromes suitable for use in flow cytometry are known in the art. Such fluorochromes include, e.g., R-phycoerythrin (PE), FITC (fluorescein), PerCP, APC (allophycocyanin), Cy5, DAPI, 7-AAD (7-aminoactinomycin D), PI (Propidium Iodide), Alexa Fluor®, Pacific Blue/Orange®, Cascade Blue/Orange®, and tandem dyes such as PE-Cy5, PE-Cy5.5, PE-Cy7, PerCP/Cy5.5, APC/Cy5.5, APC/Cy7 and PerCP/Cy5.5. The bead can for example be labeled with fluorescein isothiocyanate (FITC) or allophycocyanin (APC). The antibody can for example be labeled with R-phycoerythrin (PE). The antibody, which may correspond to a monoclonal or a polyclonal antibody, is preferably directly labeled. However, it may also be indirectly labeled, especially when the antibody is a polyclonal antibody.

As readily apparent to the skilled in the art, at least one, two, three, four or five antigen-specific PBMC may be detected simultaneously, by using at least at least one, two, three, four or five beads each coated with different antigens.

When more than one antigen-specific PBMC is detected, the different types of beads, coated with different antigens, may be labeled with different fluorochromes.

The beads for use in the method in accordance with the invention are well known in the art. As used herein, the term “bead” refers to a bead (microsphere) suitable for use in flow cytometry. Such beads typically have a size within 3 to 20 micron. They can be made of various materials such as latex, metal (in the case of magnetic beads) or polystyrene. In the frame of the present invention, they are preferably made of latex. Such beads are commercially available and may for example be obtained from BD Biosciences, ImmuneTech, Rules Based Medicine, Bio-Rad, BioSource, Linco Research, Qiagen, and R&D Systems.

When more than one antigen-specific PBMC is detected, the different types of beads, coated with different antigens, may optionally correspond to beads that are distinguishable from each other by their size and/or by their composition (i.e. latex or metal for instance).

The method according to the invention may be both be carried out with beads coated with a given, specific HLA antigen (e.g. for detecting the presence or the absence of B lymphocytes expressing antibodies against HLA-DRB4, HLA-DPB1 or HLA-A0201), and with a cocktail of beads coated with different antigens (e.g. for detecting the presence or the absence of B lymphocytes expressing antibodies against HLA antigens of class 1 or 2).

In a preferred embodiment, the bead is a LABScreen® bead (One-Lambda, California, USA). These beads correspond to commercially available latex beads that are coated with HLA antigens.

Step (b) of the method according to the invention may for example be performed by contacting the fluorescently-labeled antibody with the sample and carrying out an incubation, e.g. an incubation of about 15 min to 2 hours, preferably of about 20 min. The incubation is preferably carried out in the dark at about 0 to 5° C. The reaction mixture may then be centrifuged (e.g. at 1500 rpm for 5 minutes) and the pellet resuspended in a new solution (e.g. a PBS solution).

Step (c) of the method according to the invention may for example be performed by contacting the sample obtained at step (b) with the coated beads, and carrying out an incubation, e.g. an incubation of about 15 min to 2 hours, preferably of about 30 min. The incubation is preferably carried out in the dark at about 0 to 5° C.

Step (d) of the method according to the invention comprises detecting if the second complex is present or absent by flow cytometry. Suitable flow cytometers to implement the method typically comprise:
at least one laser and at least two fluorescence detectors, so as to allow the detection of at least two different fluorochomes, and
a cell sorter so as to sort heterogeneous sample into two or more containers, one subpopulation at a time, or one cell at a time, based upon the cell or particles' size or shape and/or upon their fluorescent characteristics.
   Suitable cell sorting flow cytometer or FACS® include, e.g. the Becton Dickinson FACSAria Cell Sorter, the Becton Dickinson FACSCalibur Analytical Flow Cytometer, the Becton Dickinson LSRII, and the Beckman-Coulter ELITE-ESP. This step allows detecting the presence of the absence of “rosettes”, i.e. of the second complex according to the invention (see FIG. 2).

The method may optionally comprise step (e), which consists in quantifying the second complex. This can for example be done by:
i. measuring the fluorescence of the PBMC population;
ii. measuring the fluorescence of the antigen-specific PBMC subpopulation; and
iii. calculating the ratio, the frequency and/or the percentage of the antigen-specific PBMC subpopulation (compared to the PBMC population).

The method may optionally comprise step (f), which consists in isolating the second complex, for instance when a cell sorting flow cytometer is used. The antigen-specific PBMC subpopulation can be purified from the retrieved complexes, and the cells can further be cultured to expand and/or characterize the antigen-specific PBMC subpopulation.

In particular, cells of the antigen-specific PBMC subpopulation (for example an antigen specific of the donor) can be immortalized in order to produce a cell line expressing the antibody specifically binding to the antigen or expended to produced anti-donor specific B cells. Libraries of cell lines expressing different antibodies can thus be obtained.

Diagnostic Applications and Drug Monitoring

PBMC play a critical role in the immune response. For example, PBMC play a role in infections, transplant rejections and autoimmune responses. Therefore, detecting and/or isolating antigen-specific PBMC subpopulations is useful for diagnosing, prognosing, monitoring and/or studying disorders linked with an immune response.

Therefore, the method for detecting the presence or the absence of at least one an antigen-specific peripheral blood mononuclear cell described hereabove is preferably carried out with a sample obtained from a patient suffering from, or at risk of suffering from, an immune disorder. It may be repeated at least at two different points in time in order to monitor the appearance or the progression of an immune disorder, and/or to monitor the response of the patient to a drug.

As used throughout the present specification, an “immune disorder” refers to any disorder due to a dysfunction of the immune system, and/or due to an overactive and/or unwanted response of the immune system. Immune disorders include, e.g., transplant rejection (graft versus host disorder or GVDH, chronic rejection, acute rejection, etc.), transfusion reaction, autoimmune disorders (type I diabetes, graves disorder, rheumatoid arthritis, multiple sclerosis, etc.), and allergic reactions (allergic rhinitis, type 1 hypersensitivity, hay fever, asthma, anaphylatoxic reaction, etc.).

In a preferred embodiment, the immune disorder is a transplant rejection. By “transplant” is meant any transplant of an organ or a tissue from a donor to a recipient. This term includes autografts (when the patient is also the donor), allografts (from a donor who is a genetically different member of the same species), isografts (from a donor to a genetically identical recipient such as an identical twin) and xenografts (from one species to another). The transplant may possibly be a split transplant (the organ is divided) or a domino transplant (several organs are simultaneously transplanted).

The invention further pertains to a method for diagnosing whether an individual suffers from an immune disorder, which comprises the step of detecting the presence or the absence of an antigen-specific peripheral blood mononuclear cell (PBMC) in a patient by the method described hereabove in the paragraph entitled “Detection of antigen-specific peripheral blood mononuclear cells”, wherein the presence of an antigen-specific peripheral blood mononuclear cell (PBMC) indicates that said patient suffers from said immune disorder.

As used herein, the term “diagnosing” includes determining whether a patient suffers or not from a disease, predicting whether a patient is at risk of suffering from a disease, determining the likelihood of recovery from a disease, and predicting the probable course and/or outcome of a disease.

For instance, in a patient who has received a transplant from a donor, a high level of HLA-specific PBMC has been shown to be a predictor of poor outcome of the patient (Terasaki, 2003, Am J Transplant 3:665-673; Terasaki and Ozawa, 2004, Am J Transplant 4:438-443; Terasaki and Ozawa, 2005, Transplantation 80:1194-1197).

The invention also pertains to a method for monitoring the response of a patient to a drug, said method comprising the steps of:
a) detecting the presence or the absence of antigen-specific PBMC in a patient by the method described hereabove in the paragraph entitled “Detection of antigen-specific peripheral blood mononuclear cells” before onset of a treatment with said drug;
b) repeating step (a) after onset of said treatment;
c) comparing the levels of antigen-specific PBMC detected at step (a) and (b); and, optionally,
d) correlating a difference in said levels of antigen-specific PBMC with the effectiveness of the drug for treating said patient.
   In particular, a decrease in the levels of antigen-specific PBMC detected at step (a) and (b) indicates that the drug is efficient for treating the patient. For instance, in a patient who has received a transplant from a donor and who is undergoing a treatment against graft rejection, a decrease in the levels of HLA-specific PBMC indicates that the drug is efficient for treating the patient.

The levels of antigen-specific PBMC detected in the above method preferably correspond to the ratio, the frequency and/or the percentage of antigen-specific PBMC.

However, the level of antigen-specific PBMC may also refer to the presence or the absence of such antigen-specific PBMC.

Kits According to the Invention

The invention is further directed to a kit suitable for carrying out the methods according to the invention. Such a kit may comprise:
a fluorescently-labeled antibody specifically recognizing peripheral blood mononuclear cells (PBMC); and
at least one fluorescently-labeled bead coated with an antigen that is specifically recognized by a subpopulation of said PBMC.

The kit may further comprise one or more biochemical reagents useful for carrying out the method according to the invention such as e.g. a buffer solution such as PBS and a wash buffer.

The kit may also comprise instructions for use in the diagnosis of an immune disorder.

All references cited herein, including journal articles or abstracts, published or unpublished patent application, issued patents or any other references, are entirely incorporated by reference herein, including all data, tables, figures and text presented in the cited references.

The invention will be further evaluated in view of the following examples and figures.

### BRIEF DESCRIPTION OF THE FIGURES

FIG. 1: Principle of the method according to the invention: example of the detection of HLA-specific B lymphocytes. A sample comprising B lymphocytes was first incubated with mouse anti-human CD19 IgG conjugated to R-Phycoerythrin (PE), and was then incubated with LABScreen® beads which were carriers of an HLA antigen and which were labeled with APC. The HLA-specific B lymphocytes were thus covered by beads, yielding “rosettes” (i.e. the second complex according to the invention). The rosettes can be detected through detection of PE and APC by flow cytometry (FACS). 1: PBMC; 2: mouse anti-human CD19 IgG conjugated to PE; 3: first complex according to the invention; 4: beads carrying an HLA antigen and labeled with APC; 5: second complex according to the invention; 6: cell that is not a B lymphocyte.

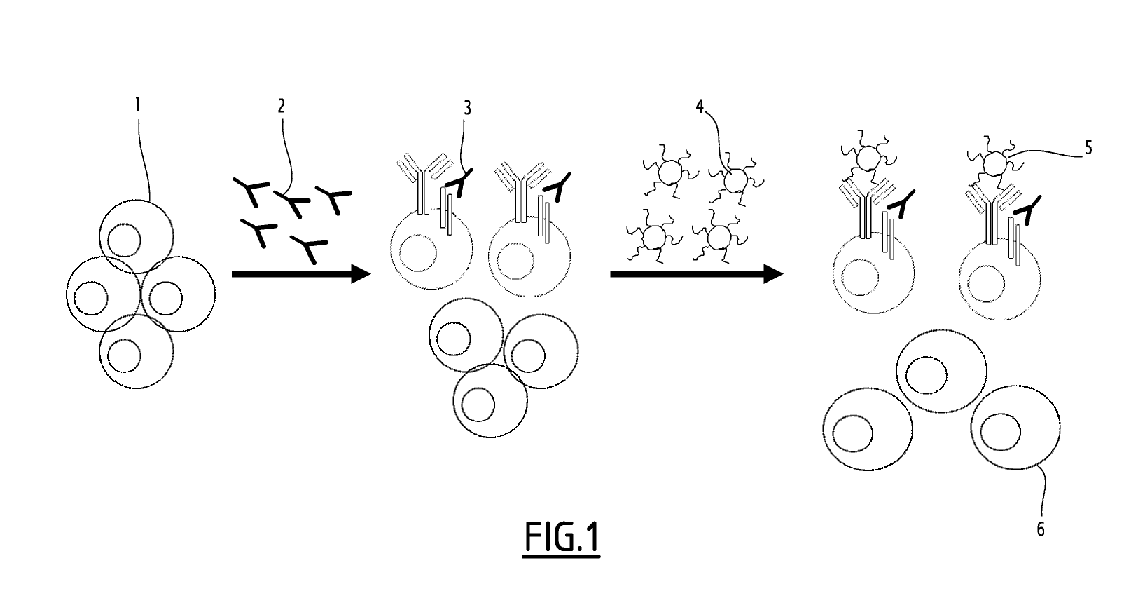

FIG. 2: Detection of “rosettes” (i.e. of the second complex according to the invention) by flow cytometry. The antigen-specific PBMC covered by the beads coated with HLA have a larger diameter, which can be detected by flow cytometry. The right panel shows how B lymphocytes and beads are visualized on a scatter plot of a flow cytometer. M stand for monocytes, L stand for lymphocytes and D stand for cell debris.

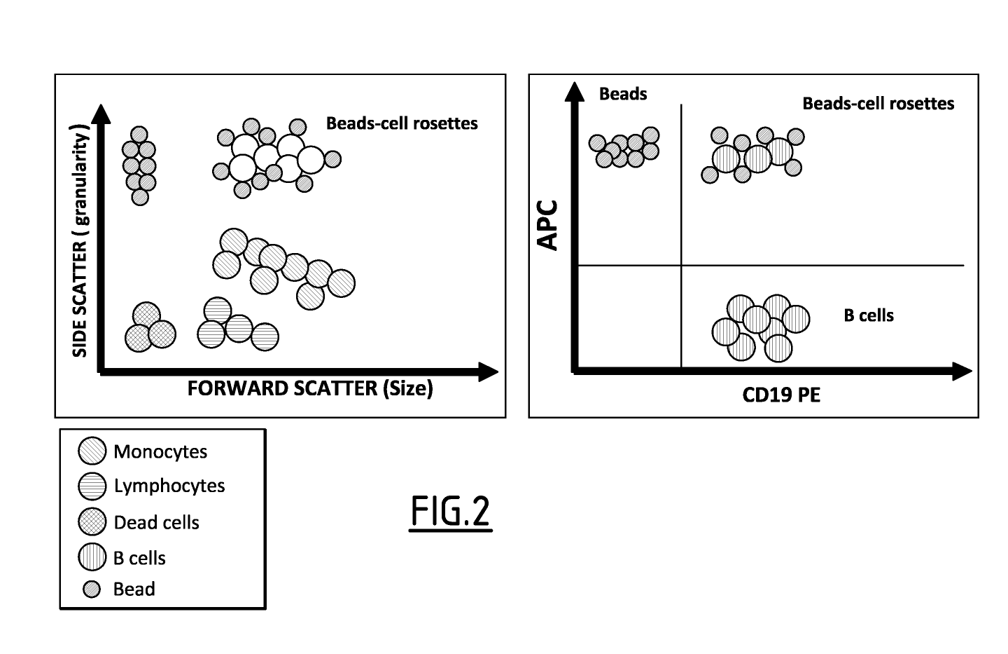

### EXAMPLES

### Example 1

### Protocols

1.1. Preparation of an Antibody-PMBC Complex

The leukocytes of human peripheral blood (PBL) were purified by gradient Ficol. 1.10⁶ PBL were resuspended in 100 μl of buffer solution (PBS) with 5 μl of anti-CD19 R-phycoerythrin (PE) and incubated in the dark on ice for 20 minutes. The PBL were washed in 10 ml PBS then centrifuged at 1500 rpm for 5 minutes.

1.2. Preparation of Beads

LABScreen® beads (One-Lambda, California, USA) were mixed before use, either by gentle agitation on vortex or pipette. A 10× wash buffer (ref. cat. LSPWABUF, One-Lambda, California, USA) was diluted in distilled water to prepare a wash buffer. The volume of logs required was calculated on the basis of 10 μl bead to 1.10⁶ leukocytes. 1 ml of wash buffer was added to 10 μl of beads and gently agitated on vortex. The suspension was then centrifuged at 2500 rpm for 5 minutes. The supernatant was aspirated and discarded. The beads were resuspended in a solution of filtered PBS (50 μl of PBS per 10 μl of beads previously added to the wash buffer).

1.3. Preparation of the Rosettes

After washing, 50 μl of beads were incubated with 1.10⁶ peripheral blood leukocytes in 1.5 ml and thoroughly but gently agitated by vortex for one minute. A 30 minutes ice-incubation was then performed in the dark.

1.4. Data Acquisition by Flow Cytometry

The rosettes were visualized by flow cytometry. B lymphocytes are identified by a mouse anti-human CD19 IgG conjugated to R-Phycoerythrin (PE). The rosettes are positively marked both by fluorochrome PE (CD19) and by APC (beads). These rosettes were endowed with a larger size than other B lymphocytes, and they thus appeared on the upper and right part of the cytometer' screen.

1.5. Retrieval of Antigen-Specific PMBC

The rosettes were then isolated using a cell sorting cytometer. Sorting allows the physical separation of cells or particles of interest from a heterogeneous population. The flow cytometer relies on the principle of electrostatic deflection of charged droplets: the PBMCs are aspirated from the sample and injected one by one by a nozzle under a continuous flow of PBS. When applying to the flow a wave of determined vibration frequency and amplitude, the flow broke to form drops, each of these drops were characterized by specific point determined by its position and its onset time. Upon interception of the PBMC cell with the laser beam, the deflected light and the emitted fluorescence generated a signal which was processed by the sorting program to determine whether the PBMC cell should be isolated or not according to defined criteria. If a PBMC cell of interest was detected, the cytometer load the drop which contains said PBMC cell of interest for further sorting. In passing through the deflection plates heavily charged, this drop was offset by the side of the plate of opposite polarity and collected. By applying different charges left and right, it was possible to sort multiple populations simultaneously. The sorting method may be modified to select a maximum purity and maximum efficiency (for a small and precious population) or a maximum of precision. The rosettes can thus be isolated from the other cells and may be further characterized.

### Example 2

### Detection of HLA Specific B Lymphocytes

The technique was validated ex vivo in samples of patients who received two transplants, and who had anti-HLA antibodies directed against circulating antigens of their donor.

Experiments were first carried out with a patient with DRB4 and DPB1 anti-HLA (of class II). DRB4 and DPB1 anti-HLA were distinguished through a difference in fluorescence level. Using the method according to the invention, B lymphocytes specifically directed against antigens of these two DRB4 and DPB1 HLA were detected with a cocktail of beads coated with purified class II HLA antigens, with a frequency of 0.01% for each antigen in the blood of patients. B lymphocytes were identified using co-labeling with anti-CD19 antibodies.

Further experiments were conduced in patients with class I anti-HLA of known specificity (namely anti-HLA-A0201 specificity).

The sensitivity of the technique was evaluated on an independent group of 8 patients with identification of B lymphocytes directed specifically against antigens HLA-A0201 with respective frequencies of 0.35% 0.04% 0.12% 0.05% 0.06% 0.12%, 0.05% and 0.06%.

No signal was detected on monocytes (CD11c, Mac1), plasma cells (CD38 PE), or with microbeads coated with purified HLA Class I or II, or non-immunized male subjects.

In summary, it was shown that the method according to the invention allowed an easy and sensitive detection of anti-HLA antibodies of class I and of class II, both when the HLA specificity was known and when it was unknown prior to the detection.

### Example 3

### Specificity of the Method According to the Invention

The specificity of the technique was evaluated on an independent panel of 3 non-immunized healthy volunteers (i.e. without circulating antibodies). In these three individuals, the frequency of B lymphocytes directed against the A0201-HLA antigen was found to be of 0%. It was thus demonstrated that the method according to the invention is highly specific.

### Example 4

### Use of the Method According to the Invention for Unraveling Pathogenesis of Transplant Rejection

In order to study the phenotype and the function of the antigen-specific B lymphocytes, antigen-specific B lymphocytes are quantified and isolated using the method according to the invention in two cohorts of patients, with and without chronic rejection respectively, before and after transplantation. The kinetics of appearance of these antigen-specific B lymphocytes, the presence of donor specific HLA antibodies and the development of chronic rejection are analyzed.

The peripheral blood of 2 separate groups of transplant patients is analyzed. Group A includes patients whose cells were frozen in prospective transplant before and 1 year after transplantation, concomitantly with a systematic biopsy (i.e. a biopsy in the absence of any symptom systematically carried out one year after the transplant). Group B includes patients whose cells were frozen in prospective transplant before and after transplantation, concomitantly with a biopsy for cause at least 1 year after transplant (i.e. a biopsy consecutive to a symptom and/or an abnormal transplant).

The kinetics of appearance of circulating antibodies to donor and frequency of specific B lymphocytes from the donor is followed for each patient of the 2 groups. The statistical power of this study is between 10 and 20% (n=5 (10%) for group A, n=30 (20%) for group B). These data are correlated to clinical data of these patients and are listed in the computerized database and validated DIVAT.

For 30 patients, B lymphocytes specific donor are isolated and characterized as regard to the following parameters: antibody production in vitro after stimulation (CD40L, CD40L+CpG, CD40L+anti-human IgM), transcriptional and phenotypic profile (classification BM1-BM5 (IgD+/−CD38−/CD27++/−), specific markers of activated B lymphocytes or differentiated (Blimp, Bcl2 . . . ) and functional abilities (proliferation, apoptosis, cytokine production and capacity of antigen presentation in lymphocyte reactions mixed).

The above study allows establishing the nature of the relationship between the frequency of specific B lymphocytes from the donor, the appearance of HLA antibodies and the fate of the graft. This study helps in understanding the pathogenesis of chronic rejection, and in the discovery of new treatments.

1. A method for detecting the presence or the absence of at least one an antigen-specific peripheral blood mononuclear cell, said method comprising the steps of:
a) providing or obtaining a sample comprising peripheral blood mononuclear cells;
b) contacting said sample with a fluorescently-labeled antibody specifically recognizing a peripheral blood mononuclear cell (PBMC), whereby a first complex between said labeled antibody and said PBMC is formed;
c) contacting the sample obtained at step (b) with at least one fluorescently-labeled bead coated with an antigen that is specifically recognized by said antigen-specific PBMC, whereby, if said sample comprises said antigen-specific PBMC, a second complex between beads and the first complex is formed;
d) detecting, by flow cytometry, the presence or the absence of said second complex, thereby detecting the presence or the absence of said antigen-specific PBMC;
e) optionally quantifying said second complex; and
f) optionally isolating said second complex;
wherein said fluorescently-labeled antibody and said fluorescently-labeled beads are not labeled with the same fluorochrome.

2. A method according to claim 1, wherein said peripheral blood mononuclear cells are B lymphocytes.

3. The method according to claim 1, wherein said antibody specifically recognizing B lymphocytes is an anti-CD19 antibody.

4. The method according to claim 1, wherein said antigen that is specifically recognized by said antigen-specific PBMC is an HLA antigen encoded by the major histocompatibility complex (MHC).

5. The method according to claim 1, wherein said bead is a latex bead.

6. The method according to claim 1, further comprising the step of calculating the percentage of PBMC that correspond to said antigen-specific PBMC.

7. The method according to claim 1, wherein said sample is blood.

8. The method according to claim 1, wherein said sample is from a patient suffering from, or at risk of suffering from, an immune disorder.

9. The method according to claim 8, wherein said immune disorder is selected from the group consisting of a transplant rejection, a transfusion reaction, an autoimmune disorder and an allergic reaction.

10. The method according to claim 1, wherein:
said sample is from a patient who has received, or who is in need of receiving, a transplant from a donor; and
said antigen is an antigen encoded by the MHC of the donor, but that is not encoded by the MHC of the patient.

11. The method according to claim 1, wherein:
said patient is a patient suffering from, or at risk of suffering from, an autoimmune disorder.
said antigen is an auto-antigen indicative of an autoimmune disorder.

12. The method according to claim 8, wherein said detection of the presence or the absence of antigen-specific PBMC in the patient is repeated at least at two different points in time in order to monitor the appearance or the progression of an immune disorder, and/or to monitor the response of the patient to a drug.

13. A method for diagnosing whether an individual suffers from an immune disorder, which comprises the step of detecting the presence or the absence of antigen-specific peripheral blood mononuclear cells (PBMC) in a patient by,
a) providing or obtaining a sample comprising peripheral blood mononuclear cells;
b) contacting said sample with a fluorescently-labeled antibody specifically recognizing a peripheral blood mononuclear cell (PBMC), whereby a first complex between said labeled antibody and said PBMC is formed;
c) contacting the sample obtained at step (b) with at least one fluorescently-labeled bead coated with an antigen that is specifically recognized by said antigen-specific PBMC, whereby, if said sample comprises said antigen-specific PBMC, a second complex between beads and the first complex is formed;
d) detecting, by flow cytometry, the presence or the absence of said second complex, thereby detecting the presence or the absence of said antigen-specific PBMC;
e) optionally quantifying said second complex; and
f) optionally isolating said second complex;
wherein said fluorescently-labeled antibody and said fluorescently-labeled beads are not labeled with the same fluorochrome, and wherein the presence of antigen-specific peripheral blood mononuclear cells (PBMC) indicates that said patient suffers from said immune disorder.

14. A method for monitoring the response of a patient to a drug, said method comprising the steps of:
a) detecting the presence or the absence of antigen-specific PBMC in a patient by;
i) providing or obtaining a sample comprising peripheral blood mononuclear cells;
ii) contacting said sample with a fluorescently-labeled antibody specifically recognizing a peripheral blood mononuclear cell (PBMC), whereby a first complex between said labeled antibody and said PBMC is formed;
iii) contacting the sample obtained at step (b) with at least one fluorescently-labeled bead coated with an antigen that is specifically recognized by said antigen-specific PBMC, whereby, if said sample comprises said antigen-specific PBMC, a second complex between beads and the first complex is formed;
iv) detecting, by flow cytometry, the presence or the absence of said second complex, thereby detecting the presence or the absence of said antigen-specific PBMC;
v) optionally quantifying said second complex; and
vi) optionally isolating said second complex;
wherein said fluorescently-labeled antibody and said fluorescently-labeled beads are not labeled with the same fluorochrome,
b) repeating step (a) after onset of said treatment;
c) comparing the levels of antigen-specific PBMC detected at step (a) and (b);
and, optionally,
d) correlating a difference in said levels of antigen-specific PBMC with the effectiveness of the drug for treating said patient.

15. A kit comprising:
i. a fluorescently-labeled antibody specifically recognizing a PBMC, wherein said antibody is an anti-CD3 antibody if the PBMC population to be detected is the T cell population, an anti-CD4 antibody if the PBMC population to be detected is the cytotoxic T lymphocyte (CTLs) population, and an anti-CD19 or anti-CD20 antibody if the PBMC population to be detected is the B lymphocyte population;
ii. fluorescently-labeled beads coated with at least one antigen that is specifically recognized by a subpopulation of PBMC;
iii. optionally one or more biochemical reagents; and
iv. optionally instructions for use in the diagnosis of an immune disorder.

16. The method according to claim 13, wherein said immune disorder is selected from the group consisting of a transplant rejection, a transfusion reaction, an autoimmune disorder and an allergic reaction.

17. The method according to claim 13, wherein:
said sample is from a patient who has received, or who is in need of receiving, a transplant from a donor; and
said antigen is an antigen encoded by the MHC of the donor, but that is not encoded by the MHC of the patient.

18. The method according to claim 13, wherein:
said patient is a patient suffering from, or at risk of suffering from, an autoimmune disorder.
said antigen is an auto-antigen indicative of an autoimmune disorder.

19. The method according to claim 13, wherein said detection of the presence or the absence of antigen-specific PBMC in the patient is repeated at least at two different points in time in order to monitor the appearance or the progression of an immune disorder, and/or to monitor the response of the patient to a drug.

20. The method according to claim 14, wherein said immune disorder is selected from the group consisting of a transplant rejection, a transfusion reaction, an autoimmune disorder and an allergic reaction.

21. The method according to claim 14, wherein:
said sample is from a patient who has received, or who is in need of receiving, a transplant from a donor; and
said antigen is an antigen encoded by the MHC of the donor, but that is not encoded by the MHC of the patient.

22. The method according to claim 14, wherein:
said patient is a patient suffering from, or at risk of suffering from, an autoimmune disorder.
said antigen is an auto-antigen indicative of an autoimmune disorder.
